(19) United States
(12) Patent Application Publication
(10) Pub. No.: US 2002/0116355 A1
(43) Pub. Date: Aug. 22, 2002

(54) System, method and computer program product for establishing collaborative work groups using networked thin client devices

(76) Inventors: Jeremy Roschelle, Palo Alto, CA (US); Philip Vahey, San Francisco, CA (US)

Correspondence Address: PATENT ADMINISTRATOR, TESTA, HURWITZ & THIBEAULT, LLP, HIGH STREET TOWER, 125 HIGH STREET, BOSTON, MA, 02110, US

(21) Appl. No.: 09/791,901

(22) Filed: Feb. 21, 2001

(51) Int. Cl. G06F 15/18

(52) U.S. Cl. 706/62; 706/927

(57) ABSTRACT

A system, method and computer program product are provided for establishing a collaborative work group. A collaborative work group identifier is generated in response to a request from a first device. Further, the collaborative work group identifier is transmitted to other devices. To this end, the first device and the other devices are established as a collaborative work group using the collaborative work group identifier.

### FIELD OF THE INVENTION

The present invention relates to networked devices, and more particularly to facilitating collaboration among students using networked devices.

### BACKGROUND OF THE INVENTION

In classroom settings, an increasingly recommended pedagogical practice is breaking students up into small groups to work together for a short time. These groups may have two to six or more students. A group may work together for a portion of a 50 minute class period, such as 20 minutes, and then report their work and disband. During their time together, students must coordinate their use of resources, and often must produce a shared work product.

For example, a mathematics teacher might ask students to work in a group to plot a set of data points and find the line of best fit. The group might move to a different location in the classroom, pull together a set of resources such as paper, textbooks, and one or more computers. Within the group, students might take different roles, such as calling out data points, plotting them, exploring lines with a computer-based graphing system, and reporting. When the allotted time ends, each group might be asked to report its findings, including transferring their work products to shared storage or a shared display.

Where technology is involved, the practice of forming short-term work groups in a classroom is currently difficult to implement. Most generic work group support systems assume groups will be fairly long-term (operating over weeks or months), and thus administrative procedures that take a few minutes to a few hours are not an undue burden. When the groups will only last 20 minutes, however, spending even as little 2-3 minutes to set up each of 5-10 groups is problematic.

A solution would enable students to rapidly and spontaneously indicate they are working as a group, minimizing the administrative burden on the teacher. Once students form a group, the solution should allow them to share resources, store work products centrally, and prepare work products for publication or presentation to the class. The solution should allow the teacher or administrator to establish appropriate storage locations, permissions, and security restrictions for the newly formed groups.

### DISCLOSURE OF THE INVENTION

A system, method and computer program product are provided for establishing a collaborative work group. A collaborative work group identifier is generated in response to a request from a first device. Further, the collaborative work group identifier is transmitted to other devices. To this end, the first device and the other devices are established as a collaborative work group using the collaborative work group identifier.

In one embodiment of the present invention, the devices may include thin client devices such as wireless devices. As an option, such wireless devices include handheld wireless devices.

In another embodiment of the present invention, the collaborative work group identifier may be transmitted to the other devices utilizing directional beaming. Further, a network may optionally be utilized. Such network may include a local area network (LAN). Optionally, the LAN may take the form of an omni-directional LAN.

Optionally, the devices may be networked to a server that stores information associated with the collaborative work group. As a further option, each of the other devices may be registered in response to the transmission of the collaborative work group identifier thereto. In one embodiment, each of the other devices may be registered automatically.

Further, privileges may be granted to users of certain devices. This may be accomplished by transmitting a token or password to the devices, wherein the devices are granted restricted privileges using the token or password.

### BRIEF DESCRIPTION OF THE DRAWINGS

FIG. 1 illustrates one exemplary environment in which the present invention may be implemented;

FIG. 2 depicts an exemplary operating environment including one or more thin client devices in connection with a host computer system;

FIG. 3 illustrates an exemplary wireless thin client device;

FIG. 4 shows a representative hardware environment associated with the host computer system of FIG. 2;

FIG. 5 illustrates a method for establishing a collaborative work groups in an educational environment using networked devices; and

FIG. 6 illustrates one example of use of the present invention.

### DESCRIPTION OF THE PREFERRED EMBODIMENTS

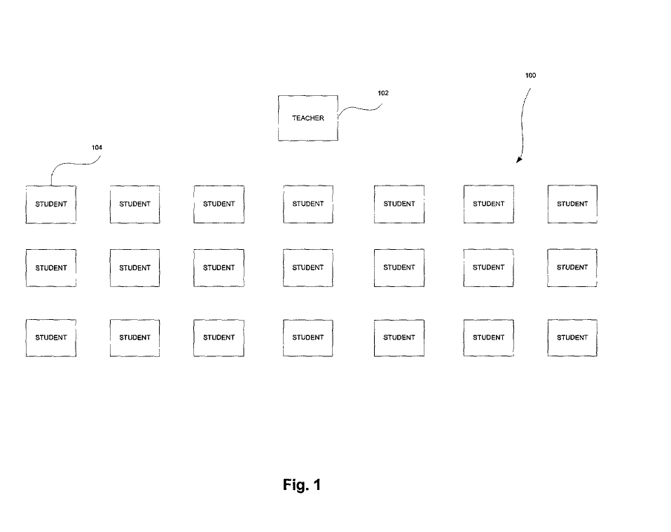

FIG. 1 illustrates one exemplary environment in which the present invention may be implemented. As shown, an educational environment 100 may be provided with a plurality of students 104 and a teacher 102. It should be noted that any type of environment may be used where a plurality of users are formed in a group which is instructed, addressed, etc. by a head of the group. It should also be understood that the group of students 104 need not necessarily be congregated in a single location.

One exemplary embodiment involves the following system components:

networked thin client devices, one for each group participant

a computer or networked thin client device for the group leader

a programming language that operates on the client devices

a peer-to-peer directional communication capability between client devices

a networked server computer

a programming language that operates on the server

a networking protocol through which the clients and server can send messages to each other, and optionally among clients

a data description language in which the clients and server read and write messages for each other, and optionally among clients

a display visible by the group leader and participants

Descriptions for preferred and alternative embodiments are set forth for each component below; the overall assemblage can be realized in many different combinations without undue difficulty. In particular, alternative embodiments may utilize mixed kinds of devices, mixed kinds of program languages, mixed networking protocols, and mixed data description languages.

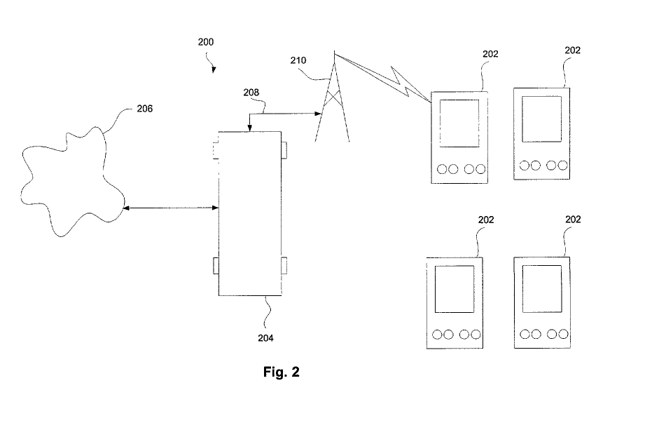

FIG. 2 depicts an exemplary operating environment 200 including one or more thin client devices 202 in connection with a host computer system 204. In one embodiment, each of the students 104 may be equipped with one of the thin client devices 202, and the teacher 102 may be capable of using the host computer system 204. As an option, the teacher 102 may also interface with the host computer system 204 utilizing one of the thin client devices 202. The host computer system 204 may optionally be connected to remote sources of data information on the Internet 206. As an option, the thin client devices 202 may be wireless devices. In such embodiment, the host computer system 204 may include a peripheral interface adapter that provides for the bi-directional transfer of the data via an interconnect line 208 to a transceiver 210 that supports wireless communications with one or more wireless devices.

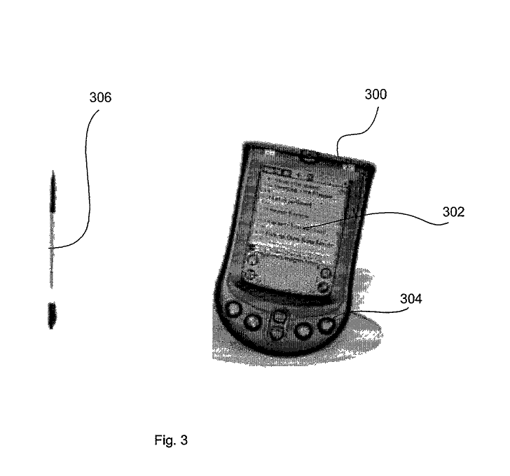

In one embodiment, each networked thin client device is a handheld, palm-sized computer. FIG. 3 illustrates an exemplary wireless thin client device 300. Such wireless device 300 is preferably constructed with a plastic case housing a display panel 302, a keypad 304, and a stylus 306.

In the present description, use of the term “networked thin client device” is meant to include a wide variety of personal computing devices with any one or more of various features. For example, such networked devices may have: (a) a means of graphic and textual output (b) a means of pixel-oriented spatial input and textual input and/or (c) a means of networking with other like devices and with a server. Optionally they devices may have a means of peer-to-peer communication with a single, appropriately equipped partner device. Embodiments could include but are not limited to: personal digital assistants, handheld gaming toys, cell phones, graphing calculators, tablet-based computers, and personal computers.

One preferred embodiment is battery powered; alternative embodiments can use any appropriate power source. One preferred device has a plastic or metal case; alternative embodiments can use any casing material appropriate for devices that will be handled by participants. One preferred device provides conveniences such as a cover for protecting the display and a contrast control; alternative embodiments might not have such conveniences, or many more conveniences might be provided. A variety of software can be run on one preferred devices, including address, datebook, to-do list and notebook applications, although none of these software applications are strictly required, and many more such applications could be used in conjunction with an alternative embodiment.

In one preferred embodiment the graphic and textual output is accomplished by means of a 160×160 pixel Liquid Crystal Display (LCD) screen, capable of displaying four levels of gray. In alternative embodiments, the screen may be larger or smaller, may be black and white only, or may display more levels of gray, or may display color. This screen may or may not have a backlight. In another alternative embodiment the screen could utilize a cathode ray tube (CRT) monitor. In another alternative embodiment the screen could consist of paper with ink droplets which can be caused to display or hide digitally, in a pixel array. As additional novel display technologies arise, little effort is foreseen to embody the invention, provided that the display is controllable by software in a manner similar to the control of today's pixel displays.

In one preferred embodiment, spatial and textual input is accomplished by use of a stylus, to write upon the stylus-sensitive LCD screen. The physical contact is recognized by operation system software on the client, and made available to client programming languages as logical input, such as entering text, drawing a line, or selecting a location on the screen. Optionally, buttons on the device can be used to indicate input. In the present embodiment, buttons are used for selecting a client application, and to indicate operations within the client program. Optionally, a keyboard may be attached to the device and used to produce input. In one alternative embodiment, input might be accomplished via audio input; voice recognition software could translate voice input into commands. In another alternative embodiment, spatial input may be accomplished via a physical pointing device such as a mouse, trackball, or joystick. In another alternative embodiment, one or more buttons might be used to indicate spatial positioning. In another alternative embodiment, eye gaze recognition might be used to accomplish spatial input. As additional novel input devices arise, little effort is foreseen to embody the invention, provided that the input is made available to client software in a similar manner as stylus, keyboard, or pointing input is made available to today's client software.

One preferred embodiment incorporates an infrared (IR) emitter and sensor, which enables the exchange of messages or data with a peer device (popularly called “beaming”). The peer device may be of a similar make and model as the first device, or may be another make or model of device supporting a similar IR emitter and sensor and a compatible communications protocol. In alternative embodiments, other methods of directional communication may be used, or beaming may not be supported by the device.

One preferred embodied also uses a networked thin client as the computer for the group leader. This networked thin client has the same characteristics listed above. In alternative embodiments, a desktop or laptop computer could be used for the group leader. In alternative embodiments, the server computer might be used directly by the group leader. In alternative embodiments, an infrared or radio frequency remote control might be used by the group leader to control the server. In alternative embodiments the teacher might control the server computer through voice commands. In alternative embodiments, the teacher might control the server computer by actions on a large flat markable display, such as a whiteboard, which has been instrumented so as to send commands to the server.

In one preferred embodiment, the ANSI C programming language is used to create client software on the thin client device, utilizing the operating system provided by the manufacturer on the device. The invention, however, does not require any features specific to ANSI C, and many other programming languages could be used. Object oriented programming is a popular technique. An alternative implementation could use an object-oriented language, such as C++ or Java. Alternative embodiments could also use interpreted languages, such as Basic, or JavaScript. On some devices, there is no support for languages other than assembly language (some models of Texas Instruments' graphing calculators are examples); alternative embodiments could be written in assembly language or machine code.

In one preferred embodiment, the textual program is compiled producing object code, the object code is transferred to the client, and the client code may then be executed. In an alternative embodiment, the textual program may be compiled to a machine-independent format, such as Java byte code. The machine-independent code may then be transferred to the client, and the client code may be executed using a special program that interprets byte code and produces the desired effects (such an interpreter is conventionally called a “virtual machine”). In alternative embodiments, the textual program may be transferred to the client without prior compilation, and executed via a program called an interpreter. An interpreter reads the program directly and produces the desired effect. Basic is an example of an interpreted language.

Alternative embodiments have been described using a variety of programming languages and means of executing programs written in those languages. Although programming languages differ in the means they afford for expression, and the means they offer for execution, different programming languages can be used to the produce the equivalent input/output and information processing behaviors. No particular difficulties are foreseen in deploying the invention in alternative embodiments using any programming language that can execute on the client device and produce equivalent input and output, and perform the requisite information processing steps.

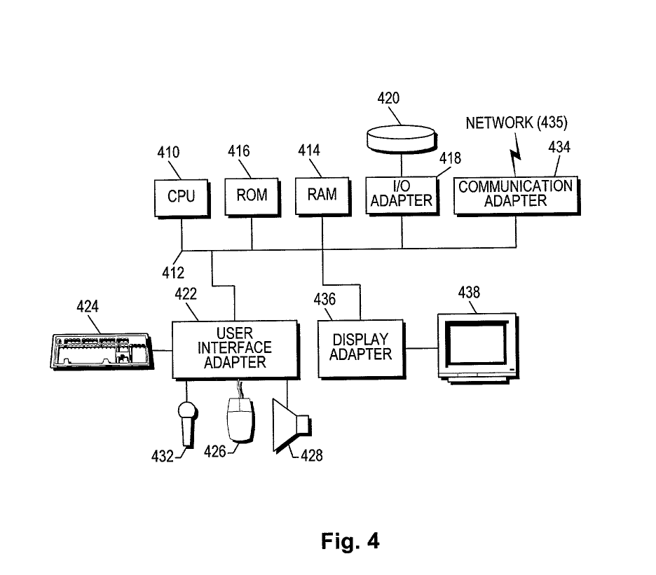

FIG. 4 shows a representative hardware environment associated with the host computer system of FIG. 2. Such figure illustrates a typical hardware configuration of a workstation in accordance with a preferred embodiment having a central processing unit 410, such as a microprocessor, and a number of other units interconnected via a system bus 412.

The workstation shown in FIG. 4 includes a Random Access Memory (RAM) 414, Read Only Memory (ROM) 416, an I/O adapter 418 for connecting peripheral devices such as disk storage units 420 to the bus 412, a user interface adapter 422 for connecting a keyboard 424, a mouse 426, a speaker 428, a microphone 432, and/or other user interface devices such as a touch screen (not shown) to the bus 412, communication adapter 434 for connecting the workstation to a communication network 435 (e.g., a data processing network) and a display adapter 436 for connecting the bus 412 to a display device 438.

In one preferred embodiment, the server computer is a stock Power Macintosh G4 with an 802.11b networking card installed. This server computer has a central processing unit, random access memory (RAM), read only memory (ROM), disk storage, Ethernet networking hardware and connectors, and capabilities for attaching input and output devices, principally a keyboard, mouse, and CRT monitor. The Power Macintosh G4 also has an antenna, card, and software support wireless networking via the IEEE 802.1 lb standard. The server computer has operating system software capable of executing server programs, which can intercommunicate with clients and other servers, and can access RAM, ROM, and disk storage. Alternative embodiments could use other computer hardware. A wide variety of processing chips might be used, including Pentium, SPARC, ARM, Crusoe, or other processing chips. More than one processing chip might be used in the same server. A wide variety of storage devices might be used. In alternative embodiments storage might reside on devices outside the main computer box, connected by dedicated wiring, or by general-purpose networking. In alternative servers, other physical networking layers might be supported, as will be discussed below. In alternative embodiments other operating systems might be used, such as Linux, Solaris, Window95, Window98, Windows NT, or Windows 2000. In alternative embodiments, a coordinated collection of computers might collectively act as the server. In alternative embodiments, the server might be a network appliance, with no provision for input and output devices, other than a connection to a network. In alternative embodiments, the server might also reside on a client device, with one client acting as server, or acting as both client and server. As described immediately below, there are many alternative networking embodiments. An alternative server embodiment may not have an Ethernet card and connector, but would only have the networking hardware and connectors used for its specific networking option. Likewise, if 802.11b is not the networking embodiment used, the server might not have an 802.11b card and antenna.

One preferred embodiment uses Java as the programming language on the server. In particular, the Serviet Application Programmer Interface (API) is used to write server programs. Textual server programs are compiled into Java byte code. A virtual machine executes this byte code. One preferred embodiment utilizes a Java web server program within which the program executes. In alternative embodiments the Java program could be executed in conjunction with other web server programs, such as Apache, Netscape, or Microsoft web servers. The discussion of alternative program languages presented with regard to client program also pertains to server programming. A wide variety of program languages and means of executing programs offer equivalent capabilities. Alternative embodiments could thus be constructed many different programming languages and execution facilities. A list of possible languages, which is by no means exclusive, includes C, C++, Python, Perl, Active Server Pages, Java Server Pages, JavaScript and Basic.

Networking is generally conceived of in terms of layers; although 7 or more layers are commonly used, the present discussion will be simplified to three layers: physical, transport, and application.

One preferred embodiment uses a combination of infrared (IR) beaming and Ethernet cabling as physical layer. Alternative embodiments of the physical layer could use radio frequency (RF) communication in the 900 megahertz, 2.4 Gigahertz, or other spectrums, as an alternative to IR. Alternative embodiments could also use wired connections to a partner device (such as a cell phone) which is then connected to the network. It is the nature of internet protocols to allow many combinations of physical topology and infrastructure to interoperate, and thus endless combinatorics prevent us from listing all possible alternative embodiments of the physical layer. At any rate, any physical layer will suffice as long as it connects the devices and allows a suitable network protocol to be used to exchange information among them.

One preferred embodiment uses TCP/IP for the middle transport layers. For IR communication Point to Point Protocol (PPP) is used over irDA to make a TCP/IP connection to a wired Ethernet switch, which then provides TCP/IP connectivity to the rest of the wired network. One preferred embodiment runs TCP/IP over PPP over irDA. Alternative embodiments could use TCP/IP over Bluetooth, 802.11, or HomeRF standards. An alternative embodiment could substitute AppleTalk, a newer version of TCP/IP or another transport protocol for the present use of TCP/IP. Transports are generally equivalent, for the purposes herein, provided they can deliver messages between the two addressable devices in a timely and reasonably dependable fashion, and those messages can support an application protocol such as HTTP and data such as XML.

Sockets are used at the application layer, using a custom protocol for communication. This protocol is a simplified version of the HyperText Transport Protocol (http), and allows for requesting information from the server via GET operations and sending information to the server via POST operations. A secondary socket channel is also used to send change notification messages from server to client. The protocol for this channel consists of POSTing a “changed” message with optional timestamp information, as well as an optional indication as to what changed. An alternative embodiment could use the Object Exchange protocol (OBEX). Another alternative embodiment could use HTTP 1.0 or greater; many programming languages contain libraries or classes that directly support these protocols without direct reference to sockets. Little difficulty is foreseen in using alternative logical representations of a communications channel between devices, so long as it provides read and write operations that receive and send structured textual and/or binary data between addressable devices, along the lines of the http get and post messages.

One preferred embodiment uses a simplified form of the extensible markup language (XML) for structuring the data messages which are exchanged among clients and the server. An alternative embodiment could use IITML. An alternative embodiment could use a binary message format that contains equivalent information. An alternative embodiment could use XML without simplification. An alternative embodiment could use another structured text description language, so long as matching encoders and decoders can be written for both sides of the communication channel.

One preferred embodiment includes a public display, visible by the group leader and group participants. A computer projector is used to cast this image upon a reflective, flat surface at the front of the room. In alternative embodiments, a wide variety of projection technologies could be used. The projection could be from in front of or behind the screen. The projection unit might contain a light source, or rely upon an external light source. In alternative embodiments, the large public display might be large CRT monitor or LCD display. In alternative embodiments, participants may not be in the same room, and the “public” display may be a display area reserved for this purpose on their remote computer or device. In general, any device may serve as the public display as long as (1) it can display computer graphics images (2) the computer graphics images can be controlled by a computer, such as the server or the group leader's computer, (3) all participants can see it when required by the group activity to do so.

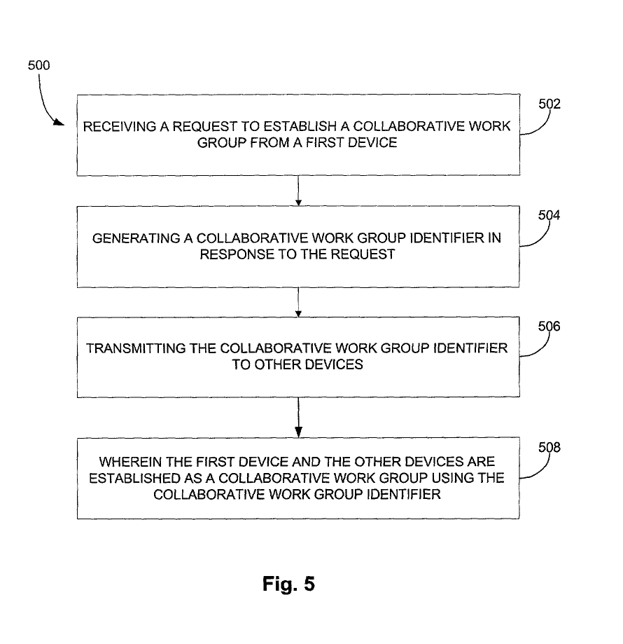

FIG. 5 illustrates a method 500 for establishing a collaborative work group in an educational environment using networked devices. In one embodiment of the present invention, the networked devices may include thin client devices. Further, such thin client devices may include wireless devices. Still yet, the wireless devices may include hand-held wireless devices such as personal digital assistants (PDAs) each including a stylus, as set forth hereinabove during reference to FIGS. 2 and 3. It should be noted, however, that any type of networked device may be employed per the desires of the user.

Initially, in operation 502, a request to establish a collaborative work group is received from a first device. As an option, a user of the first device may be established as a head, or leader, of the collaborative work group. It should be noted, however, that no special personal qualities are required to be a leader of the collaborative work group. Further, the request may be initiated by navigating a menu depicted on the display of the first device. Actual receipt of the request may occur over a wireless or hard line communication medium.

Thereafter, in operation 504, a collaborative work group identifier is generated in response to the request. It should be noted that the collaborative work group identifier may be generated arbitrarily, without initiation by the request. Further, such identifier may be a digital certificate, token, password, binary code, or any other type of identifying mechanism that is unique to the collaborative work group being established. It may be generated randomly, selected from a list of possible identifiers, or by any other means. In one embodiment, the request for the identifier may be received and the identifier generated on a host computer. As an option, however, the request for the identifier may be received and the identifier generated on the first device.

Further, the collaborative work group identifier is transmitted to other devices. Note operation 506. Again, this may occur over a wireless or hard line communication medium. Further, the generated identifier may be transmitted from the host computer or the first device. In one embodiment of the present invention, the collaborative work group identifier may be transmitted to the other devices utilizing a network. Such network may include a local area network (LAN). Optionally, the LAN may take the form of an omni-directional LAN, i.e. 802.11. In operation, the first and other devices may be capable of communicating using directional beaming to allow transmission of the identifier.

Upon receiving the collaborative work group identifier in operation 506, each of the other devices may be registered. In one embodiment, each of the other devices may be registered automatically.

To this end, the first device and the other devices are established as a collaborative work group using the collaborative work group identifier. See operation 508. As such, the identifier may be used during communication to allow privileged activities to occur among the other devices. Privileges may vary from device to device. This may be accomplished by transmitting unique tokens or passwords to various devices, wherein the devices are granted varying privileges using the token or password. It should be understood that the privileges may relate to accessing and/or editing specific material on the host computer, or some other shared domain.

As an option, the first and other devices may be networked to the host computer, or server, that is persistent. During use, the server stores information associated with the collaborative work group.

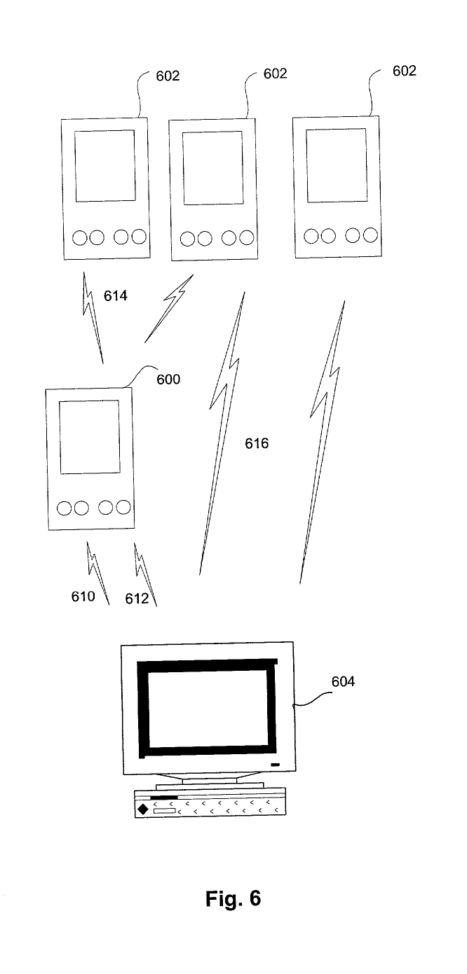

FIG. 6 illustrates one example of use of the present invention. It is important to note that the present example is merely for illustration purposes, and should not be construed as limiting in any manner. The general principles of the present invention may be applied in any desired manner to accomplish varying objectives.

As shown, a first student may activate an interface element on a first device 600 for requesting a new unique work group identifier in step 610 from a server 604, and receiving the same in step 612. Thereafter, other students are allowed to join the team using a directional beaming capability of other devices 602 to communicate with the first device 600. See step 614. By this method, the work group identifier is passed to each member. Upon receiving a token, each of the other devices 602 uses an omni-directional LAN to register as a group member (automatically) with the server 604. Note step 616. Once a group is created, server software on the LAN can create a shared workspace, and give various privileges to group members to read, write, etc. to the shared space.

As an option, group members can pass tokens to non-group members giving them restricted access privileges, such as read-only. This may be accomplished by requiring such devices to log-in prior to accessing information on the server 604. Such tokens could be valid for one use only. Further, the non-work group tokens could be encrypted relative to the device to which the token is beamed, so they cannot be further copied.

The present invention thus employs a mix of two kinds of networking: one type which can be physically directed at a peer and another type which is omni-directional in a classroom sized space. The present invention makes it quick and easy to form ad hoc teams which is useful in schools. It should be noted that the present invention might also be useful in many workplace settings where an ad hoc group wants to create a shared workspace. This can be used for any desired purpose, i.e. to share notes from a meeting, etc.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for establishing a collaborative work group in an educational environment, comprising the steps of:
(a) generating a collaborative work group identifier; and
(b) transmitting the collaborative work group identifier to a plurality of devices operated by a plurality of students;
(c) wherein the devices are established as a collaborative work group using the collaborative work group identifier for allowing the students to work in a collaborative work group under the direction of a teacher.

2. The method as recited in claim 1, wherein the devices include thin client devices.

3. The method as recited in claim 2, wherein the thin client devices include wireless devices.

4. The method as recited in claim 3, wherein the wireless devices include hand-held wireless devices.

5. The method as recited in claim 1, wherein the collaborative work group identifier is transmitted among the devices utilizing infrared beaming, wherein the infrared beaming is directed to one of the devices.

6. The method as recited in claim 1, wherein the collaborative work group identifier is transmitted among the devices utilizing a network and a user interface that allows selection of at least one of the devices.

7. The method as recited in claim 6, wherein the network includes a local area network (LAN).

8. The method as recited in claim 1, wherein the collaborative work group identifier is transmitted among the devices utilizing physical contact.

9. The method as recited in claim 1, wherein the devices are networked to a server that stores information associated with the collaborative work group.

10. The method as recited in claim 9, and further comprising the step of registering each of the other devices in response to the transmission of the collaborative work group identifier thereto.

11. The method as recited in claim 10, wherein each of the other devices is registered automatically.

12. The method as recited in claim 9, and further comprising the step of granting privileges to users of each of the other devices.

13. The method as recited in claim 12, and further comprising the step of transmitting a token or password to the devices, wherein the devices are granted restricted privileges using the token or password.

14. The method as recited in claim 1, wherein the collaborative work group identifier is generated by the networked system in response to receiving a request to establish a collaborative work group from a first device.

15. The method as recited in claim 1, wherein the collaborative work group identifier is generated randomly to provide unique identifiers.

16. The method as recited in claim 1, wherein the collaborative work group identifier is transmitted to the devices utilizing peer-to-peer communication.

17. A computer program product for establishing a collaborative work group in an educational environment, comprising:
(a) computer code for generating a collaborative work group identifier; and
(b) computer code for transmitting the collaborative work group identifier to a plurality of devices operated by a plurality of students;
(c) wherein the devices are established as a collaborative work group using the collaborative work group identifier for allowing the students to work in a collaborative work group under the direction of a teacher.

18. A system for establishing a collaborative work group in an educational environment, comprising:
(a) logic for generating a collaborative work group identifier; and
(b) logic for transmitting the collaborative work group identifier to a plurality of devices operated by a plurality of students;
(c) wherein the devices are established as a collaborative work group using the collaborative work group identifier for allowing the students to work in a collaborative work group under the direction of a teacher.

19. A method for establishing a collaborative work group in an educational environment, comprising the steps of:
(a) generating a collaborative work group identifier;
(b) transmitting via a first communications link the collaborative work group identifier to a plurality of devices operated by a plurality of students; and
(c) registering the collaborative work group identifier with a networked system via a second communications link;
(d) wherein the devices are established as a collaborative work group using the collaborative work group identifier, and have controlled access to resources coupled to the networked system for allowing the students to work in a collaborative work group under the direction of a teacher.
